(19) United States
(12) Patent Application Publication
(10) Pub. No.: US 2021/0240095 A1
(43) Pub. Date: Aug. 5, 2021

(54) ELECTROPHOTOGRAPHIC INK COMPOSITIONS

(71) Applicant: Hewlett-Packard Development Company, L.P., Spring, TX (US)

(72) Inventors: Adi Vinegrad, Nes Ziona (IL); Yaron Grinwald, Nes Ziona (IL); Gregory Katz, Nes Ziona (IL)

(21) Appl. No.: 17/050,756

(22) PCT Filed: Nov. 1, 2018
(86) PCT No.: PCT/US2018/058691

§ 371 Date: Oct. 26, 2020

(51) Int. Cl. G03G 9/08; G03G 9/135; G03G 9/13

(52) U.S. Cl. CPC G03G 9/0823; B82Y 40/00; G03G 9/13; G03G 9/1355

(57) ABSTRACT

The present disclosure relates to an electrophotographic ink composition. The composition comprises thermoplastic polymer, solder material, conductive filler and liquid carrier. The present disclosure also relates to a method of printing a conductive trace on a print substrate. The method comprises electrophotographically printing the electrophotographic ink composition described above onto a print substrate.

### BACKGROUND

Electrostatic printing processes, sometimes termed electrophotographic printing processes, can involve creating an image on a photoconductive surface, applying an ink having charged particles to the photoconductive surface, such that they selectively bind to the image, and then transferring the charged particles in the form of the image to a print substrate.

The photoconductive surface is on a cylinder and is often termed a photo imaging plate (PIP). The photoconductive surface is selectively charged with a latent electrophotographic image having image and background areas with different potentials. For example, an electrophotographic ink composition including charged toner particles in a carrier liquid can be brought into contact with the selectively charged photoconductive surface. The charged toner particles adhere to the image areas of the latent image while the background areas remain clean. The image is then transferred to a print substrate (e.g., paper) directly or, more commonly, by being first transferred to an intermediate transfer member, which can be a soft swelling blanket, which is often heated to fuse the solid image and evaporate the liquid carrier, and then to the print substrate.

### DETAILED DESCRIPTION

Before the present disclosure is disclosed and described, it is to be understood that this disclosure is not limited to the particular process steps and materials disclosed in this disclosure because such process steps and materials may vary. It is also to be understood that the terminology used in this disclosure is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used in this disclosure, “carrier fluid”, “carrier liquid,” “carrier,” or “carrier vehicle” refers to the fluid in which polymers, particles, charge directors and other additives can be dispersed to form a liquid electrophotographic composition or liquid electrophotographic composition. The carrier liquids may include a mixture of a variety of different agents, such as surfactants, co-solvents, viscosity modifiers, and/or other possible ingredients.

As used in this disclosure, “electrophotographic composition” or “electrostatic composition” generally refers to a composition, which is suitable for use in an electrophotographic or electrostatic printing process. The electrophotographic composition may comprise chargeable particles of polymer dispersed in a carrier liquid.

As used in this disclosure, “co-polymer” refers to a polymer that is polymerized from at least two monomers. The term “terpolymer” refers to a polymer that is polymerized from 3 monomers.

As used in this disclosure, “melt index” and “melt flow rate” are used interchangeably. The “melt index” or “melt flow rate” refers to the extrusion rate of a resin through an orifice of defined dimensions at a specified temperature and load, reported as temperature/load, e.g. 190° C./2.16 kg. In the present disclosure, “melt flow rate” or “melt index” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

As used in this disclosure, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used in this disclosure, “melt viscosity” generally refers to the ratio of shear stress to shear rate at a given shear stress or shear rate. Testing may be performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa-s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrophotographic composition.

A polymer may be described as comprising a certain weight percentage of monomer. This weight percentage is indicative of the repeating units formed from that monomer in the polymer.

If a standard test is mentioned in this disclosure, unless otherwise stated, the version of the test to be referred to is the most recent at the time of filing this patent application.

As used in this disclosure, “electrostatic printing” or “electrophotographic printing” refers to the process that provides an image that is transferred from a photo imaging plate either directly or indirectly via an intermediate transfer member to a print substrate. As such, the image may not be substantially absorbed into the photo imaging substrate on which it is applied. Additionally, “electrophotographic printers” or “electrostatic printers” refer to those printers capable of performing electrophotographic printing or electrostatic printing, as described above. An electrophotographic printing process may involve subjecting the electrophotographic composition to an electric field, e.g. an electric field having a field gradient of 1-400V/μm, or more, in some examples 600-900V/μm, or more.

As used in this disclosure, “substituted” may indicate that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, thioaryl, etc.

As used in this disclosure, “heteroatom” may refer to nitrogen, oxygen, halogens, phosphorus, or sulfur.

As used in this disclosure, “alkyl”, or similar expressions such as “alk” in alkaryl, may refer to a branched, unbranched, or cyclic saturated hydrocarbon group, which may, in some examples, contain from 1 to about 50 carbon atoms, or 1 to about 40 carbon atoms, or 1 to about 30 carbon atoms, or 1 to about 10 carbon atoms, or 1 to about 5 carbon atoms, for example.

The term “aryl” may refer to a group containing a single aromatic ring or multiple aromatic rings that are fused together, directly linked, or indirectly linked (such that the different aromatic rings are bound to a common group such as a methylene or ethylene moiety). Aryl groups described in this disclosure may contain, but are not limited to, from 5 to about 50 carbon atoms, or 5 to about 40 carbon atoms, or 5 to 30 carbon atoms or more, and may be selected from, phenyl and naphthyl.

Unless the context dictates otherwise, the terms “acrylic” and “acrylate” refer to any acrylic or acrylate compound. For example, the term “acrylic” includes acrylic and methacrylic compounds unless the context dictates otherwise. Similarly, the term “acrylate” includes acrylate and methacrylate compounds unless the context dictates otherwise.

As used in this disclosure, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description in this disclosure.

As used in this disclosure, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented in this disclosure in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used in this disclosure, weight % (wt %) values are to be taken as referring to a weight-for-weight (w/w) percentage of solids in the composition, and not including the weight of any carrier fluid present.

In one aspect, there is provided an electrophotographic ink composition comprising thermoplastic polymer, solder material, conductive filler and liquid carrier.

In some examples, there is provided an electrophotographic ink composition comprising thermoplastic polymer, solder material, conductive filler, charge adjuvant and/or charge director, and liquid carrier.

The electrophotographic ink composition may comprise toner particles comprising the thermoplastic polymer, solder material and conductive filler. In some examples, the electrophotographic ink composition may comprise toner particles comprising the thermoplastic polymer, solder material, charge adjuvant and/or charge director, and conductive filler.

The toner particles may comprise composite particles of thermoplastic polymer and at least one of the solder material, charge adjuvant and/or charge director, and conductive filler. In some examples, the toner particles may comprise composite particles of thermoplastic polymer and solder material. In some examples, the toner particles may comprise composite particles of thermoplastic polymer and conductive filler. In some examples, the toner particles may comprise composite particles of the thermoplastic polymer, solder material and conductive filler. In some examples, the toner particles may comprise composite particles of thermoplastic polymer, solder material, charge adjuvant and/or charge director, and conductive filler.

In another aspect, there is provided a method of printing a conductive trace on a print substrate. The method may be used to print a printed circuit. The method comprises electrophotographically printing an electrophotographic ink composition as described herein onto a print substrate.

In yet another aspect, there is provided a printed substrate comprising a conductive trace. The conductive trace comprises thermoplastic polymer, solder material and conductive filler. In some examples, the conductive trace may comprise thermoplastic polymer, solder material, charge adjuvant and/or charge director and conductive filler. The printed substrate comprising the conductive trace may be used in or in the manufacture of an electronic device.

Solder material may be printed by electrophotographic printing to form a conductive trace on a print substrate. The heat applied during the electrophotographic printing process may heat the solder material, such that, with e.g. the application of pressure onto the printed solder material, electrical contact can be established between particles or domains of the solder material to allow a conductive trace to be deposited onto the print substrate.

It has been found, however, that electrical contact between the domains or particles of the solder material can be enhanced by incorporating a conductive filler, for example, carbon nanotubes, in the electrophotographic ink composition. The conductive filler can improve the electrical contact between particles of solder material. Thus, in some examples, the trace produced may have a higher electrical conductivity. In other examples, a conductive trace may be deposited on a print substrate at a lower blanket temperature and/or faster printing speeds, for example, where the image may be heated for a shorter duration during the printing step. In some examples, a conductive trace may be deposited on a print substrate with e.g. a reduced need to apply force or pressure onto the printed image to establish electrical contact between particles of the solder material. In some examples, a conductive trace may be deposited on a print substrate with e.g. a reduced need to apply heat in combination with force or pressure onto the printed image to establish electrical contact between particles of the solder material.

### Solder Material

Any suitable solder material may be employed. Examples of suitable solder material include metals and metal alloys. In some examples, the metal or metal alloy may have a melting of point of less than about 200° C., or less than about 150° C., or less than about 130° C., or from about 50° C. to about 200° C., or from about 55° C. to about 150° C., or from about 56° C. to about 140° C., or from about 58° C. to about 130° C., or from about 60° C. to about 120° C. The solder material may be selected so as to have a melting point lower than the temperature to which the print substrate and/or intermediate transfer member (e.g. blanket) is heated to in the electrophotographic printing process (see below).

Suitable solder materials may comprise a solider alloy of two or more of the following metals: tin, lead, copper, zinc, indium, silver, bismuth, gold, aluminium, antimony, silver and cadmium. The solder alloy may comprise tin and/or lead. In some examples, the solder alloy may comprise tin. In some examples, the solder alloy may comprise tin in the absence of lead. Where tin is present in the solder alloy, it may be present in an amount of, for example, 5 to 90 weight % of the total weight of the solder alloy. In some examples, tin may be present in an amount of 10 to 80 weight %, for instance, 12 to 60 weight % of the total weight of the solder alloy.

In some examples, the solder alloy comprises tin and at least one further metal selected from lead, copper, zinc, indium, silver, bismuth, gold, antimony and cadmium. In some examples, the solder alloy comprises tin and at least one further metal selected from bismuth and indium. In some examples, the solder alloy comprises tin, bismuth and indium. In one example, the solder alloy is Field's alloy comprising 32.5 weight % bismuth, 61 weight % indium and 16.5 weight % tin. In other examples, the solder alloy comprises tin and at least one metalloid selected from germanium and silicon.

In some examples, the solder material may be a solder alloy comprising tin and bismuth. The alloy may be Bismuth/Tin alloy—58 wt %/42 wt % with a melting point of 138° C. (e.g., INDALLOY® #281 from Indium Corporation).

In some examples, the alloy may be an alloy of bismuth, indium and tin. An example is a Bismuth/Indium/Tin alloy—57 wt %/26 wt %/17 wt % with a melting point of 79° C. (e.g., INDALLOY® #174 from Indium Corporation). Another example may be an alloy of Indium/Bismuth/Tin alloy—51 wt %/32.5 wt %/16.5 wt % with a melting point of 60° C. (e.g., INDALLOY® #19 from Indium Corporation).

In some examples, combinations of alloys may be used.

The solder material may be present in an amount of 30 to 99 weight % of the total weight of solids in the electrophotographic solder composition. In some examples, the solder material may be present in an amount of 40 to 99 weight %, for instance, 50 to 98 weight % of the total weight of solids in the electrophotographic ink composition. In some examples, the solder material may be present in an amount of 60 to 97 weight %, for instance, 65 to 96 weight % or 70 to 95 weight % of the total weight of solids in the electrophotographic ink composition. In some examples, the solder material may be present in an amount of 75 to 93 weight % or 80 to 90 weight % of the total weight of solids in the electrophotographic ink composition.

The weight ratio of solder material to thermoplastic polymer present in the electrophotographic solder composition may be 1:30 to 1:1, for example, 1:20 to 1:3 or 1:15 to 1:5. In one example, the weight ratio of solder material to thermoplastic polymer present in the electrophotographic ink composition may be 1:10 to 1:7.

The solder material may in particulate form. For example, particles of the solder material may have a diameter (e.g. mean diameter) of from about 0.01 μm to about 50 μm, or from about 0.1 μm to about 10 μm, or from about 1 μm to about 5 μm The particle size may be measured by any known method, for example, by dynamic light scattering (DLS) and/or SEM measurements.

The solder material may be combined (e.g. ground) with thermoplastic polymer to form composite particles. The solder material may also be combined with thermoplastic polymer and conductive filler to form composite particles. For example, the solder material may be melt bonded or precipitated with thermoplastic polymer and conductive filler to form composite particles.

### Conductive Filler

As described above, the electrophotographic ink composition may comprise a conductive filler. The conductive filler may serve to improve electrical conductivity between particles or domains of the solder material. The conductive filler particles may percolate between particles or domains of the solder material, creating conductive pathways between the particles or domains.

The conductive filler may be a conductive carbon material. Suitable conductive carbon materials may be carbon materials having carbon in an sp-2 hybridized state. Examples include graphite, carbon nanotubes and graphene. Alternatively, the conductive filler may comprise metal particles, e.g. metal filings.

The conductive filler may be selected from metal particles, carbon nanotubes, graphite fibres and graphene. Mixtures of materials may be used. In some examples, the conductive filler may be carbon nanotubes. Examples of suitable carbon nanotubes include multi-walled carbon nanotubes, for instance, those supplied by Nanocyl® (e.g. NC7000™ supplied by Nanocyl®).

The conductive filler (e.g. nanotubes) may comprise elongate particles (e.g. tubes or fibres). The elongate particles may have an aspect ratio of greater than 2, for example, greater than 4, greater than 6, or greater than 8. In some examples, the conductive filler may have an aspect ratio of 10 to 40, for example, 12 to 30 or 15 to 20.

In some examples, the conductive filler may comprise particles, in which at least 30% by volume (e.g. at least 50% by volume or at least 70% by volume) of the particles measure about 0.01 μm to about 50 μm across (e.g. in their longest dimension). In some examples, the conductive filler particles may measure from about 0.1 μm to about 10 μm across, or from about 1 μm to about 5 μm across (e.g. in their longest dimension). The particle size may be measured by any known method, for example, by dynamic light scattering (DLS) and/or SEM measurements.

The conductive filler may be present in an amount of 0.1 to 10 weight % of the total weight of solids in the composition. For example, the conductive filler may be present in an amount of 0.1 to 8 weight % of the total weight of solids in the composition, for instance, 0.2 to 6 weight % or 0.4 to 5 weight % or 0.5 to 2 weight % of the total weight of solids in the composition.

In some examples, the conductive filler comprises carbon nanotubes, and the carbon nanotubes may be present in an amount of 0.1 to 10 weight % of the total weight of solids in the composition. For example, the carbon nanotubes may be present in an amount of 0.1 to 8 weight % of the total weight of solids in the composition, for instance, 0.2 to 6 weight % or 0.4 to 5 weight % or 0.5 to 2 weight % of the total weight of solids in the composition.

In some examples, the conductive filler comprises graphene. The graphene may be present in an amount of 0.1 to 10 weight % of the total weight of solids in the composition. For example, the graphene may be present in an amount of 0.1 to 8 weight of the total weight of solids in the composition, for instance, 0.2 to 6 weight % or 0.4 to 5 weight % or 0.5 to 2 weight % of the total weight of solids in the composition.

In some examples, the conductive filler comprises graphitic carbon (e.g. graphite). The graphitic carbon (e.g. graphite) may be present in an amount of 0.1 to 10 weight % of the total weight of solids in the composition. For example, the graphitic carbon (e.g. graphite) may be present in an amount of 0.1 to 8 weight % of the total weight of solids in the composition, for instance, 0.2 to 6 weight % or 0.4 to 5 weight % or 0.5 to 2 weight of the total weight of solids in the composition.

The weight ratio of solder material to conductive filler present in the electrophotographic ink composition may be 20:1 to 200:1, for example, 40:1 to 150:1 or 50:1 to 120:1. In one example, the weight ratio of solder material to thermoplastic polymer present in the electrophotographic solder composition may be 60:1 to 100:1.

### Thermoplastic Polymer

As described above, the electrophotographic ink composition comprises a thermoplastic polymer comprising a copolymer of an olefin and acrylic acid and/or methacrylic acid. In some examples, the thermoplastic polymer comprises a copolymer of an olefin and acrylic acid.

The thermoplastic polymer may be present in an amount of 1 to 50 weight % of the total weight of solids in the electrophotographic ink composition, for example, 1 to 40 weight %, 1 to 30 weight %, 1 to 20 weight % or 1 to 15 weight % of the total weight of solids in the electrophotographic ink composition.

In some examples, the polymer of the resin may be selected from ethylene or propylene acrylic acid co-polymers; ethylene or propylene methacrylic acid co-polymers; ethylene vinyl acetate co-polymers; co-polymers of ethylene or propylene (e.g., 80 wt % to 99.9 wt %), and alkyl (e.g., C1 to C5) ester of methacrylic or acrylic acid (e.g., 0.1 wt % to 20 wt %); co-polymers of ethylene (e.g., 80 wt % to 99.9 wt %), acrylic or methacrylic acid (e.g., 0.1 wt % to 20.0 wt %) and alkyl (e.g., C1 to C5) ester of methacrylic or acrylic acid (e.g., 0.1 wt % to 20 wt %); co-polymers of ethylene or propylene (e.g., 70 wt % to 99.9 wt %) and maleic anhydride (e.g., 0.1 wt % to 30 wt %); polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g., co-polymer of acrylic or methacrylic acid and at least one alkyl ester of acrylic or methacrylic acid wherein alkyl may have from 1 to about 20 carbon atoms, such as methyl methacrylate (e.g., 50% to 90%)/methacrylic acid (e.g., 0 wt % to 20 wt %)/ethylhexylacrylate (e.g., 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

In some examples, the resin may comprise a polymer having acidic side groups. Examples of the polymer having acidic side groups will now be described. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with counterion(s), such as metal counterions, e.g., a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g., Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is NUCREL® 960 (from DuPont), and example of the second polymer is NUCREL® 699 (from DuPont), and an example of the third polymer is A-C® 5120 or A-C® 5180 (from Honeywell). The first, second and third polymers may be polymers having acidic side groups as described herein. The melt viscosity can be measured using a rheometer, e.g., a commercially available AR-2000 Rheometer from Thermal Analysis Instruments, using the geometry of: 25 mm steel plate-standard steel parallel plate, and finding the plate over plate rheometry isotherm at 120° C., 0.01 hertz shear rate.

If the resin in electrophotographic ink or ink composition comprises a single type of polymer, the polymer (excluding any other components of the electrophotographic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrophotographic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g., a commercially available AR-2000 Rheometer from Thermal Analysis Instruments, using the geometry of: 25 mm steel plate-standard steel parallel plate, and finding the plate over plate rheometry isotherm at 120° C., 0.01 hertz shear rate.

The resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g., Zn, Na, Li) such as SURLYN® ionomers. The resin may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt % to about 16 wt % of the co-polymer, in some examples 10 wt % to 16 wt % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt % to about 30 wt % of the co-polymer, in some examples from 14 wt % to about 20 wt % of the co-polymer, in some examples from 16 wt % to about 20 wt % of the co-polymer in some examples from 17 wt % to 19 wt % of the co-polymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the BYNEL® class of monomer, including BYNEL® 2022 and BYNEL® 2002, which are available from DuPont®.

The polymer having ester side groups may constitute 1% or more by weight of the total amount of the resin polymers, e.g., thermoplastic resin polymers, in the electrophotographic ink composition and/or the ink printed on the print substrate, e.g., the total amount of the polymer or polymers having acidic side groups and polymer having ester side groups. The polymer having ester side groups may constitute 5% or more by weight of the total amount of the resin polymers, e.g., thermoplastic resin polymers, in some examples 8% or more by weight of the total amount of the resin polymers, e.g., thermoplastic resin polymers, in some examples 10% or more by weight of the total amount of the resin polymers, e.g., thermoplastic resin polymers, in some examples 15% or more by weight of the total amount of the resin polymers, e.g., thermoplastic resin polymers, in some examples 20% or more by weight of the total amount of the resin polymers, e.g., thermoplastic resin polymers, in some examples 25% or more by weight of the total amount of the resin polymers, e.g., thermoplastic resin polymers, in some examples 30% or more by weight of the total amount of the resin polymers, e.g., thermoplastic resin polymers, in some examples 35% or more by weight of the total amount of the resin polymers, e.g., thermoplastic resin polymers, in the electrophotographic ink composition and/or the ink printed on the print substrate. The polymer having ester side groups may constitute from 5% to 50% by weight of the total amount of the resin polymers, e.g., thermoplastic resin polymers, in the electrophotographic ink composition and/or the ink printed on the print substrate, in some examples 10% to 40% by weight of the total amount of the resin polymers, e.g., thermoplastic resin polymers, in the electrophotographic ink composition and/or the ink printed on the print substrate, in some examples 5% to 30% by weight of the total amount of the resin polymers, e.g., thermoplastic resin polymers, in the electrophotographic ink composition and/or the ink printed on the print substrate, in some examples 5% to 15% by weight of the total amount of the resin polymers, e.g., thermoplastic resin polymers, in the electrophotographic ink composition and/or the ink printed on the print substrate in some examples 15% to 30% by weight of the total amount of the resin polymers, e.g., thermoplastic resin polymers, in the electrophotographic ink composition and/or the ink printed on the print substrate.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the NUCREL® family of toners (e.g., NUCREL® 403, NUCREL® 407, NUCREL® 609HS, NUCREL® 908HS, NUCREL® 1202HC, NUCREL® 30707, NUCREL® 1214, NUCREL® 903, NUCREL® 3990, NUCREL® 910, NUCREL® 925, NUCREL® 699, NUCREL® 599, NUCREL® 960, NUCREL® RX 76, NUCREL® 2806, BYNEL® 2002, BYNEL® 2014, and BYNEL® 2020 (sold by E. I. du PONT)), the ACLYN® family of toners (e.g., ACLYN® 201, ACLYN® 246, ACLYN® 285, and ACLYN® 295), and the LOTADER® family of toners (e.g., LOTADER® 2210, LOTADER® 3430, and LOTADER® 8200 (sold by Arkema)).

The thermoplastic resin can, in some examples is present in the electrophotographic ink composition in an amount of from about 1 to about 70 wt % based on the total weight of the electrophotographic ink composition, or from about 1 to about 60 wt % based on the total weight of the electrophotographic ink composition, or from about 1 to about 50 wt % based on the total weight of the electrostatic ink composition, or from about 1 to about 40 wt % based on the total weight of the electrostatic ink composition, or from about 1 to about 30 wt % based on the total weight of the electrostatic ink composition, or from about 1 to about 20 wt % based on the total weight of the electrostatic ink composition, or from about 5 to about 15 wt % based on the total weight of the electrostatic ink composition.

In some examples, the resin constitutes less than 1 wt % by weight of the solids printed on the electrostatic ink composition, e.g., after heating, and/or rubbing, and/or plasma treatment.

As used herein, “resin,” “polymer,” “thermoplastic resin,” or “thermoplastic polymer” are used interchangeably.

### Polymerised Rosin

In some examples, a polymerised rosin may also be present in the electrophotographic ink composition. The polymerised rosin may comprise dimerized rosin acids, for example, highly dimerized rosin acids. The polymerised rosin may be present in amounts of 0 to 10 weight %, for example, 0.1 to 8 weight %, 0.5 to 6 weight % or 1 to 5 weight % of the total weight of solids in the electrophotographic ink composition.

The polymerised rosin may act as a solder flux, for example, to reduce the risk of oxidation of the solder material when the solder material is exposed to heat. The polymerised rosin may also serve to disperse the solder material in the electrophotographic ink composition.

### Charge Adjuvant

As mentioned above, the electrophotographic ink composition may include a charge adjuvant. The charge adjuvant may adsorb onto the toner particles. A charge adjuvant may be present with or without a charge director, and may be different to the charge director, and act to increase and/or stabilise the charge on particles, e.g. resin-containing particles, of an electrophotographic composition.

In some examples, the charge adjuvant may comprise a metal salt of an organic acid, for example, a metal alkylated aryl sulphonates or a metal carboxylate. In some examples, the charge adjuvant may be a divalent or trivalent alkylated aryl sulphonates or a divalent or trivalent carboxylate. An example of a suitable metal carboxylate is aluminium stearate, for instance, aluminium distearate.

The charge adjuvant may be insoluble in the liquid carrier, e.g. iso-paraffinic liquid carrier.

The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di and/or tristearate and/or aluminium di and/or tripalmitate.

The charge adjuvant can constitute about 0.1 to 5% by weight of the solids of the electrophotographic ink composition. The charge adjuvant can constitute about 0.5 to 4 by weight of the solids of the liquid electrophotographic composition. The charge adjuvant can constitute about 1 to 3% by weight of the solids of the electrophotographic ink composition.

### Charge Director

A charge director may be added to the electrophotographic ink composition.

The charge director may be soluble in the liquid carrier, e.g. iso-paraffinic liquid carrier.

In some examples, the charge director comprises nanoparticles of a simple salt and a salt of the general formula MAₙ, wherein M is a barium, n is 2, and A is an ion of the general formula [R₁—O—C(O)CH₂CH(SO₃⁻)C(O)—O—R₂], where each of R₁ and R₂ is an alkyl group e.g. as discussed above.

The sulfosuccinate salt of the general formula MAₙ is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 10 nm or less, in some examples 2 nm or more (e.g. 4-6 nm).

The simple salt may comprise a cation selected from Mg, Ca, Ba, NH₄, tert-butyl ammonium, Li⁺, and Al⁺³, or from any sub-group thereof. In one example, the simple salt is an inorganic salt, for instance, a barium salt. The simple salt may comprise an anion selected from SO₄²⁻, PO³⁻, NO₃⁻, HPO₄²⁻, CO₃²⁻, acetate, trifluoroacetate (TFA), Cr, Bf, F⁻, ClO₄⁻, and TiO₃⁴⁻, or from any sub-group thereof. In some examples, the simple salt comprises a hydrogen phosphate anion.

The simple salt may be selected from CaCO₃, Ba₂TiO₃, Al₂(SO₄)₃, Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof. In one example, the simple salt may be BaHPO₄.

In the formula [R₁—O—C(O)CH₂CH(SO₃⁻)C(O)—O—R₂], in some examples, each of R₁ and R₂ is an aliphatic alkyl group. In some examples, each of R₁ and R₂ independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇.

The charge director can constitute about 0.001% to 20%, in some examples 0.01 to 20% by weight, in some examples 0.01 to 10% by weight, in some examples 0.01 to 1% by weight of the solids of the composition. The charge director can constitute about 0.001 to 0.15% by weight of the solids of the composition, in some examples 0.001 to 0.15%, in some examples 0.001 to 0.02% by weight of the solids of the composition.

In some examples, the charge director imparts a negative charge on the electrophotographic ink composition. The particle conductivity may range from 50 to 500 pmho/cm, in some examples from 200-350 pmho/cm.

The charge director may be added to the electrophotographic ink composition together with additional liquid carrier prior to printing. This addition may be carried out to produce a dispersion with a solids content and/or particle conductivity for suitable for electrophotographic printing.

### Liquid Carrier

The electrophotographic ink composition can comprise a liquid carrier. Generally, the liquid carrier can act as a dispersing medium for the other components in the electrophotographic ink composition. For example, the liquid carrier can comprise or be a hydrocarbon, silicone oil, vegetable oil, or combination thereof. The liquid carrier can include, but is not limited to, an insulating, non-polar, non-aqueous liquid that can be used as a medium for toner particles, e.g., the particles containing the resin and the metal or metal alloy pigment(s).

The liquid carrier can include compounds that have a resistivity in excess of about 10⁹ ohm-cm. The liquid carrier may have a dielectric constant below about 5, in some examples below about 3. The liquid carrier can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof.

Examples of the liquid carriers include, but are not limited to, aliphatic hydrocarbons, isoparaffinic compounds, paraffinic compounds, dearomatized hydrocarbon compounds, and the like. In particular, the liquid carriers can include, but are not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

In some examples, the liquid carrier can constitute about 20% to 99.5% by weight of the electrophotographic ink composition, in some examples 50% to 99.5% by weight of the electrophotographic ink composition. The liquid carrier may constitute about 40 to 90% by weight of the electrophotographic ink composition. The liquid carrier may constitute about 60% to 80% by weight of the electrophotographic ink composition. The liquid carrier may constitute about 90% to 99.5% by weight of the electrophotographic ink composition, in some examples 95% to 99% by weight of the electrophotographic ink composition.

The ink, when printed on the print substrate, may be substantially free from liquid carrier. In an electrophotographic printing process and/or afterwards, the liquid carrier may be removed, e.g., by an electrophoresis processes during printing and/or evaporation, such that substantially just solids are transferred to the print substrate. Substantially free from liquid carrier may indicate that the ink printed on the print substrate contains less than 5 wt % liquid carrier, or less than 2 wt % liquid carrier, or less than 1 wt % liquid carrier, or less than 0.5 wt % liquid carrier, or less than 0.1 wt % liquid carrier. In some examples, the ink printed on the print substrate is free from liquid carrier.

### Printing Process and Print Substrate

The electrophotographic ink composition may be used to manufacture a printed trace. The printed trace may form or may form part of a printed circuit. The printed trace may be used as a conductor or a capacitor.

The method may comprise electrophotographic printing an electrophotographic ink composition as described herein onto a print substrate. The method may comprise forming a latent electrophotographic image on a photoconductive surface; contacting the photoconductive surface with the electrophotographic ink composition, such that at least some of the composition adheres to the photoconductive surface to form a developed toner image on the photoconductive surface. The toner image may then be transferred to the print substrate. Since the toner image comprises the solder material, the solder material may be transferred to the print substrate to form, for example, a conductive trace. In some examples, the toner image is transferred to the print substrate via an intermediate transfer member or blanket. The intermediate transfer member or blanket may be heated to facilitate transfer of the toner image from the photoconductive surface onto the print substrate. Heating may also cause particles of solder material to soften or fuse together to form the conductive trace. In an alternative example, the print substrate may be heated to facilitate transfer of the toner image from the photoconductive surface to the print substrate.

In some examples, the image or trace printed on the print substrate may be subjected to pressure or heat and pressure. The application of pressure or heat and pressure may improve electrical contact between domains of the printed solder material. In some examples, the method further comprises, after transferring the image to the print substrate, heating the print substrate and/or rubbing an object over the toner image on the print substrate, to decrease the electrical resistance of the toner image. Rubbing an object over the toner image may indicate contacting an object with the toner image and effecting relative lateral movement on the print substrate and the object, such that the object moves across the print image. The rubbing may involve pressing together the print substrate and the object. Rubbing may be carried out manually or in an automated manner. Rubbing may involve moving an object in contact with the ink on the paper at a different velocity relative to the paper. In some examples, the applied pressures can range from 240 kg/cm² to about 400 kg/cm², or from 280 kg/cm² to about 370 kg/cm², or from 290 kg/cm² to about 350 kg/cm², or from 300 kg/cm² to about 350 kg/cm². The object in contact with the ink and used for the rubbing may comprise a material selected from plastic, rubber, glass, metal, and paper, which may be soft or strong paper. In some examples, the rubbing element can be heated, which has been found to improve efficiency. The inclusion of the conductive filler into the electrophotographic ink composition, however, may reduce or eliminate the need for heating or applying pressure (e.g. rubbing) to the image post-printing, as the conductive filler may improve electrical contact between particles of the printed solder material such that desirable levels of conductivity can be achieved even in the absence of such post-printing treatment.

In an example of the method, the heating involves heating the intermediate transfer member and/or print substrate to a temperature of at least 80° C., in some examples at least 90° C., in some examples at least 100° C., in some examples at least 120° C., in some examples at least 130° C., in some examples at least 150° C., in some examples at least 180° C., in some examples at least 220° C., in some examples at least 250° C., in some examples at least 280° C. The heating may be carried out for a predetermined period.

In an example of the method, the heating involves heating the intermediate transfer member and/or print substrate to a temperature of from 80° C. to 250° C., for at a predetermined period of least 5 minutes, in some examples at least 10 minutes, in some examples at least 15 minutes, in some examples at least 20 minutes, in some examples at least 25 minutes, in some examples at least 30 minutes. The predetermined period may be from 5 to 60 minutes, in some examples from 15 to 45 minutes.

The photoconductive surface on which the (latent) electrophotographic image is formed or developed may be on a rotating member, e.g., in the form of a cylinder. The surface on which the (latent) electrophotographic image is formed or developed may form part of a photo imaging plate (PIP). The method may involve passing the electrophotographic ink composition described herein between an electrode, which may be stationary, and a rotating member, which may be a member having the surface having the (latent) electrophotographic image thereon or a member in contact with the surface having the (latent) electrophotographic image thereon. A voltage is applied between the electrode and the rotating member, such that e.g. toner particles adhere to the surface of the rotating member. The intermediate transfer member, if present, may be a rotating flexible member, which may be heated, e.g., to a temperature of from 60 to 140° C.

The print substrate may be any suitable substrate. The substrate may be any suitable substrate capable of having an image printed thereon. The substrate may comprise a material selected from an organic or inorganic material. The material may comprise a natural polymeric material, e.g., cellulose. The material may comprise a synthetic polymeric material, e.g., a polymer formed from alkylene monomers, including, but not limited to, polyethylene and polypropylene, and co-polymers such as styrene-polybutadiene. In some examples, the substrate, before printing, is or comprises plastic. In some examples, the substrate, before printing, is or comprises paper. The polypropylene may, in some examples, be biaxially orientated polypropylene.

Once printed, the substrate comprises a conductive trace, wherein the conductive trace comprises, thermoplastic polymer, solder material and conductive filler. The printed substrate may be useful for printed electronics applications.

Various examples will now be described.

### EXAMPLES

### Example 1

### Preparation of Thermoplastic Polymer Paste

A copolymer of ethylene and methacrylic acid (Nucryl 699 available from Dupont®) and a copolymer of ethylene and acrylic acid (Honeywell® AC5120) was ground into a paste in the presence of a paraffin solvent (Isopar®-L, 25% non-volatile solvents). The weight ratio of Nucryl 699 to Honeywell® AC5120 4:1.

Grinding was performed using a Ross mill at 120-150 degrees C. and 50 rpm for 90 min, and then the grinding rate was raised to 70 rpm for 120 min. The temperature was then lowered to room temperature and the grinding rate reduced to 50 rpm after 30 min.

### Example 2

### Preparation of Dispersion of Carbon Nanotubes (0.5 Weight %)

Multi-walled carbon nanotube powder (MWCNT powder NC7000™ supplied by Nanocel®) was mixed with iso-paraffin (Isopar® L) in a weight ratio of 1:199. The mixture was milled to prepare the carbon nanotube dispersion. An EIGER® mini mill was employed. The mixture was ground for 60 min at 500 rpm with cooling.

### Example 3

### Preparation of Electrophotographic Ink Compositions

Electrophotographic inks having the compositions shown in the tables below were prepared by grinding the listed components in a ball milling machine. The components were milled (with cooling) for 5 hours at a rate of 250 rpm.

TABLE 1
Sample I

| | | Formulation |
|---|---|---|
| | Amount | composition |
| Material | (gr) | (wt %) |
| Thermoplastic polymer | 8.4 | 7 |
| paste (Example 1) | | |
| Indium/Bismuth/Tin alloy— | 25.8 | 86 |
| 51 wt %/32.5 wt %/16.5 wt % (MCP61 ™, | | |
| supplied by 5N Plus) | | |
| Charge adjuvant (aluminium distearate) | 0.6 | 2 |
| Polymerized Rosin (Dymerex ™ available | 3.3 | 4 |
| from Eastman ®) | | |
| Carbon nanotube dispersion (Example 2 | 60 | 1 |
| Iso-paraffin (Isopar ® L) | 52 | |
| Sum | 150 | |
| % NVS (non-volatile solids) | 20% | |

TABLE 2
Sample A

| | | Formulation |
|---|---|---|
| | Amount | composition |
| Material | (gr) | (wt %) |
| Thermoplastic polymer paste (Example 1) | 116.4 | 97 |
| Carbon nanotube dispersion (Example 2) | 60 | 1 |
| Charge adjuvant (aluminium distearate) | 0.6 | 2 |
| Iso-paraffin (Isopar ® L) | 52 | |
| Sum | 200 | |
| % NVS (non-volatile solids) | 17% | |

TABLE 3
Sample B

| | | Formulation |
|---|---|---|
| | Amount | composition |
| Material | (gr) | (wt %) |
| Thermoplastic polymer paste (Example 1) | 8.4 | 7 |
| Indium/Bismuth/Tin alloy— | | |
| 51 wt %/32.5 wt %/16.5 wt % (MCP61 ™, | 26.1 | 87 |
| supplied by 5N Plus) | | |
| Charge adjuvant (aluminium distearate) | 0.6 | 2 |
| Polymerized Rosin (Dymerex ™ available | 3.3 | 4 |
| from Eastman ®) | | |
| Iso-paraffin (Isopar ® L) | 52 | |
| Sum | 150 | |
| % NVS (non-volatile solids) | 20% | |

### Example 4

The electrophotographic ink compositions of Example 3 were used to develop a 0.5 DMA (defined mass per area−mg/(cm²)) layer on a paper (cellulosic) substrate using an LEP printing press simulation. The images were not subjected to heat or pressure (e.g. rubbing) post-printing.

The electrical resistance of the images on each of the developed layers was measured. Only the image printed using Sample I was found to be conducting. The images printed using Samples A and B did not conduct.

1. An electrophotographic ink composition comprising:
thermoplastic polymer,
solder material,
conductive filler,
and
liquid carrier.

2. The composition as claimed in claim 1, wherein the solder material is present in an amount of 20 to 99 weight % of the total weight of solids in the composition.

3. The composition as claimed in claim 1, wherein the solder material is a metal or metal alloy having a melting point of less than about 200° C.

4. The composition as claimed in claim 1, wherein the solder material comprises two or more metals selected from tin, zinc, bismuth, aluminium, lead, indium, silver and cadmium.

5. The composition as claimed in claim 4, wherein the solder material comprises tin.

6. The composition as claimed in claim 5, wherein the solder material comprises tin, bismuth and indium.

7. The composition as claimed in claim 1, wherein the conductive filler is selected from metal particles, carbon nanotubes, graphite and graphene.

8. The composition as claimed in claim 7, wherein the conductive filler comprises carbon nanotubes.

9. The composition as claimed in claim 7, wherein the conductive agent is present in an amount of 0.1 to 10 weight % of the total weight of solids in the composition.

10. The composition as claimed in claim 1, which comprises polymeric rosin.

11. The composition as claimed in claim 1, wherein the total amount of thermoplastic polymer is 1 to 50 weight % of the total weight of solids in the composition.

12. The composition as claimed in claim 1, wherein the thermoplastic polymer comprises a copolymer of an olefin and methacrylic acid and/or acrylic acid.

13. The composition as claimed in claim 1, which further comprises charge adjuvant and/or charge director.

14. A method of printing a conductive trace on a print substrate, said method comprising electrophotographically printing an electrophotographic ink composition as claimed in claim 1 onto a print substrate.

15. A printed substrate comprising a conductive trace, wherein the conductive trace comprises, thermoplastic polymer, solder material and conductive filler.
